(19) United States
(12) Patent Application Publication
(10) Pub. No.: US 2013/0024772 A1
(43) Pub. Date: Jan. 24, 2013

(54) COMPUTER-BASED DISPLAY PRESENTATION TIME MANAGEMENT SYSTEM

(71) Applicants: David J. Delia, Lagrangeville, NY (US); Wayne M. Delia, Poughkeepsie, NY (US); James R. Kraemer, Santa Fe, NM (US); Tedrick N. Northway, Wood River, IL (US)

(72) Inventors: David J. Delia, Lagrangeville, NY (US); Wayne M. Delia, Poughkeepsie, NY (US); James R. Kraemer, Santa Fe, NM (US); Tedrick N. Northway, Wood River, IL (US)

(73) Assignee: International Business Machines Corporation, Armonk, NY (US)

(21) Appl. No.: 13/189,154

(22) Filed: Jul. 22, 2011

(51) Int. Cl. G06F 3/00

(52) U.S. Cl. 715/730

(57) ABSTRACT

An interactive computer supported display system for managing the time allocation of presentation segments, such as individual slides. The presentation segments are each preassigned a presentation time duration and a warning time threshold for signaling the approach to the end of the preassigned time duration of each presentation segment. The actual presentation time used during presentation of each segment is compared to the preassigned time duration and warning threshold to issue warnings to the presenter and to carry forward any surplus or deficit time due to underrun or overrun of the preassigned time. The time surplus or deficit carried forward may be allocated by adding to or subtracting from the preassigned presentation times of subsequent presentation segments based upon a preassigned priority level assigned to each presentation segment.

### BACKGROUND OF THE INVENTION

1. Field of the Invention

The present invention relates to user interactive computer supported display technology for displaying presentation segments such as individual slide and, more particularly, to interactive computer-based presentations systems for automatically managing the time assigned to the segments presented by the presenter-user.

2. Background and Related Art

Computer-based slide presentation systems, for example, allow a presenter-user to create a slide presentation including multiple slides. Each slide typically includes information on one or more topics associated with a meeting that the presenter-user plans to present to one or more individuals. A sequence of slides is typically scheduled to be presented within some relatively fixed period of time and, thus, the time spent on presenting individual slides or presentation segments needs to be managed.

### SUMMARY

A method in accordance with an embodiment includes managing time among a plurality of sequential computer-based presentation display segments where a presentation time is preassigned to each segment with each segment presented in a sequence of segments on an audience display and with each segment preassigned a warning time less than the preassigned presentation time assigned to each segment to initiate display of warning indication on a presenter workstation. The method further includes tracking the actual time a segment is presented and comparing the tracked time with the preassigned warning time to initiate warning indications to said workstation display when the warning time is reached and comparing the tracked time to the preassigned presentation time to determine any amount of over or under time variation between the actual time and preassigned presentation time and; carrying forward any variation in time to add or subtract the amount of such variation in time from the preassigned time of the next segments in the sequence of segments to be presented.

An embodiment in accordance with the above method wherein the amount of variation in time is allocated to subsequent segments based upon priority levels preassigned to the segments.

A system for managing the distribution of time allocated to a plurality of sequential computer-based presentation segments, comprising: system storage for storing a preassigned presentation time for each of said plurality of presentation segments to be presented in order on a presenter workstation display and on an audience display; system storage for storing a preassigned warning time selected to be less than said presentation time for each of said plurality of presentation segments to use for initiation of an alarm indication on the presenter workstation display if said warning time is reached; a workstation display and an audience display arranged to receive the content of the presentation segments; a processor arranged to: track the actual time elapsed for each presentation segment as it is displayed; compare the actual time elapsed to the preassigned warning time for each presentation segment; send a warning indication to the presenter workstation if the warning time is reached for a presentation segment; compare the actual time elapsed to each preassigned presentation time for each presentation segment; and carry forward any overrun or underrun variations in actual time from the preassigned presentation time to subtract or add the amount of such variations in actual time from the preassigned presentation time to a succeeding presentation segments in the sequence of presentation segments.

A computer program product for managing the distribution of time allocated to a plurality of sequential computer-based presentation segments, comprising: a computer usable medium having computer usable program code embodied therewith, the computer usable program comprising: computer usable program code configured to selectively access a stored preassigned presentation time for each of said plurality of presentation segments to be presented in order on a presenter workstation display and on an audience display; computer usable program code configured to selectively access a stored preassigned warning time selected to be less than said presentation time for each of said plurality of presentation segments to use for initiation of an alarm indication on the presenter workstation display if said warning time is reached; computer usable program code configured to commence presentation to display presentation segment content on said presenter workstation and audience display; computer usable program code configured to track the actual time elapsed for each presentation segment as it is displayed; computer usable program code configured to compare the actual time elapsed to each preassigned warning time for each presentation segment; computer usable program code configured to send a warning indication to the presenter workstation if the warning time is reached; computer usable program code configured to compare the actual time elapsed to each preassigned presentation time for each presentation segment; and computer usable program code configured to carry forward any overrun or underrun variations in actual time from the preassigned presentation time to subtract or add the amount of such variation time from the preassigned presentation time to succeeding presentation segments in said sequence of segments.

### BRIEF DESCRIPTION OF THE DRAWINGS

FIG. 1 illustrates an exemplary computer system arrangement for carrying out embodiments of the invention.

FIG. 2 shows an exemplary process embodiment for creating presentation segments.

FIGS. 3A and 3B show an exemplary process in accordance with embodiments of the invention.

FIG. 4 shows an exemplary process embodiment for allocating previous underrun time to presentation segments that follow.

FIG. 5 shows an exemplary process embodiment for allocating overrun time to presentation segments that follow.

### DETAILED DESCRIPTION OF THE DRAWINGS

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc. or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer or system, other programmable data processing apparatus, or other devices, to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices, to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

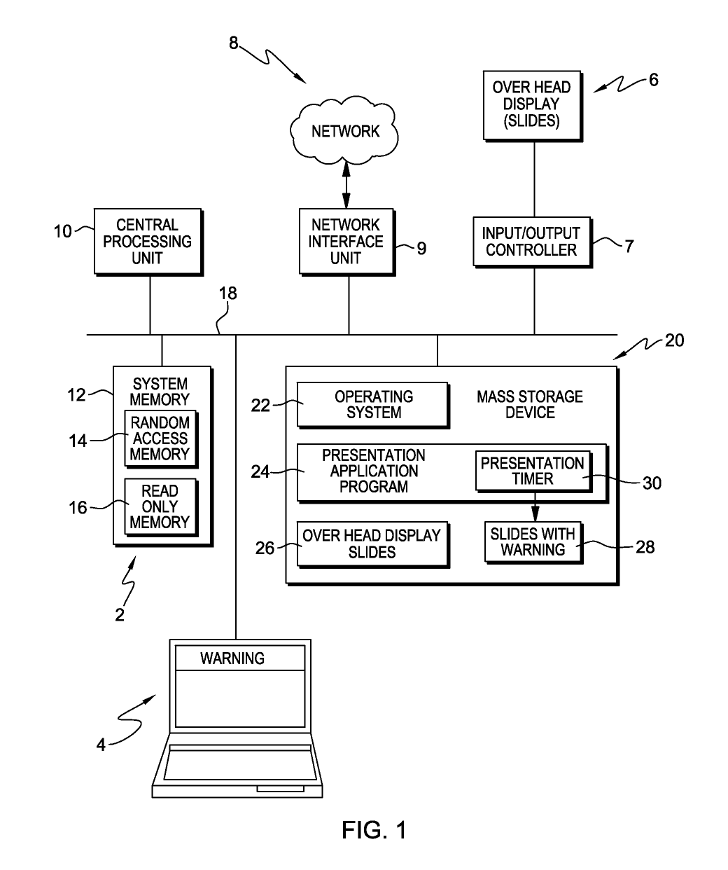

Referring now to FIG. 1, an illustrative computer system configuration 2 is shown connected to a workstation 4 comprising a display, keyboard and mouse arrangement. The computer system configuration is also shown connected to overhead display 6 through input/output controller 7 and to network 8 through network interface unit 9. The workstation may be a conventional laptop computer arrangement or merely a display and input keyboard or some combination of the two arrangements. It is understood that workstation 4 may itself house a computer system configuration, such as computer system configuration 2, or may be in addition to such computer system configuration.

Computer system configuration 2 includes a central processing unit 10 (CPU) and a system memory 12, including random access memory 14 (RAM) and read-only memory 16 (ROM), all connected to system bus 18. A basic input/output system (BIOS) that includes the basic routines that act to control transfer information between elements within and external to computer configuration 2, are stored in ROM 16. In this regard, ROM 16 includes routines and instructions for controlling the simultaneous display of content to workstation 4 display and overhead display 6 each of which display may vary somewhat. For example, the content of slides 28 (in mass storage device 20) which may be displayed on workstation 4 may include a warning indication superimposed on the presentation content of the slides to be displayed on the workstation 4 display but not on the content displayed on overhead display 6.

Mass storage device 20 is connected to CPU 10 through a mass storage controller (not shown) and bus 18. Mass storage device 20 stores an operating system 22, application programs and other program modules. The mass storage device 20 and its associated computer-readable media provide non-volatile storage for the computer system 2. It is to be understood that although the description of computer-readable media here refers to a mass storage device, such as a hard disk or CD-ROM, the computer-readable media can be any available storage media that can be accessed by computer system 2, as described above.

Mass storage device 20 also stores program instructions for the presentation application program 24 in accordance with embodiments of the invention. It is clear that any number of program modules and data files may be stored in mass storage device 20 including an operating system suitable for controlling the operation of a networked arrangement, such as, the AIX 6000™ operating system available from IBM, or Microsoft's Windows XP™ or Windows NT™ operating systems, as well as UNIX operating systems. Similarly, presentation programs, such as a version of Microsoft's Power Point Application may be stored.

Mass storage device 20 may also store the content of the presentation to be given, as shown at block 26 designated “overhead display slides”. Although the term “slides” is used here for convenience, it is to be understood that the content may be embodied and presented in a number of different ways. Accordingly, the more generic term “segments” or “presentation segments” is used herein to define a single screen of content, such as a slide, or a grouping of screens of content, such as a grouping of slides, with either arrangement having content to form a presentation unit to be presented as a segment of content with multiple segments presented sequentially or otherwise controlled accordingly. Thus, slide or segment may be used interchangeably but it is clear that either arrangement is intended.

Although mass storage unit 20 shows the “slides with warning” 28, to be displayed on workstation 4, as being stored therein, it is clear, for example, that the slides with warning may be formed from the content of “overhead display slides” 26 moved to RAM 14 with any required warnings added by CPU 10 at that time in accordance with the time conditions of presentation timer 30, as tracked according to the instruction of presentation application program 24. Alternatively, presentation timer 30 may be configured to initiate a warning, when appropriate, to be indicated on a slide shown 28 under control of presentation application program 24.

The “slides with warning” 28 may also conveniently store preassigned presentation times and preassigned warning times associated with each presentation slide segment with the actual time monitored by presentation timer 30 to track the actual elapsed presentation time for each slide or segment as it is displayed and act to trigger warning signals when the actual elapsed presentation time for each segment as it is displayed come within the preassigned warning time or exceeds the preassigned presentation time.

Although any of a variety of warning signs may be displayed on workstation 4, for simplicity and convenience, the use of a color bar may readily be employed. Where the elapsed time for the presentation of a segment is within the preassigned presentation time for the particular segment but not to the point in time where the preassigned warning time signals a warning, a green bar or frame may be shown. Where the elapsed time for the presentation of a segment enters the warning period, a yellow bar or frame may be shown. Where the elapsed time for the presentation of a segment runs over the preassigned presentation time to create an overrun condition, a red bar or frame may be shown.

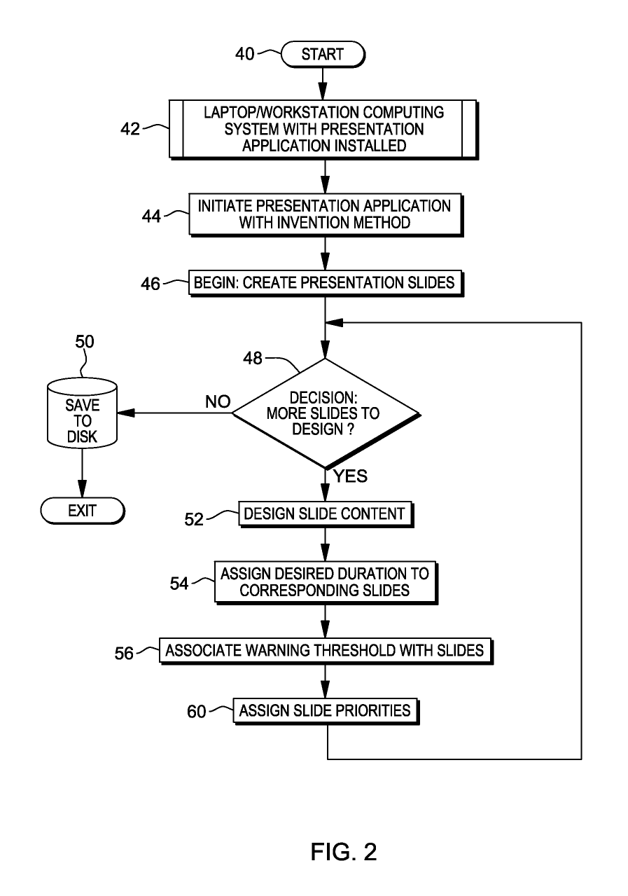

With reference to FIG. 2, there is shown an exemplary process embodiment for creating presentation segments having display content for each screen to be presented and preassigned operating parameters, such as, preassigned presentation time duration for each segment to be presented, preassigned warning times within the preassigned presentation time duration to initiate a warnings and preassigned priorities to be associated with each segment.

The process starts at block 40 wherein the workstation with computing system 42 opens the installed presentation application at block 44 to begin the creation of display segments, as shown at block 46. Block 48 acts to control the formation and saving of slides. Segments are saved to disk storage, for example, at block 50.

The sequence of segments is formed in the “yes” loop out of decision point comprising block 48. Content is formed by the presenter at the step of block 52 and the assigned presentation time duration is selected by the presenter and assigned to each segment at the step of block 54 to form the “preassigned presentation time” limit, i.e. the assigned time durations for each segment.

Similarly, the presenter selects and assigns a warning threshold to each segment at the step of block 56. This time may be a minute or two, for example, before the end of the preassigned presentation time duration, depending upon the duration of the latter.

Lastly, as shown by the step of block 60, each segment is assigned a priority. For example each segment may be assigned one of the designations “high priority”, “medium priority” or “low priority”. It is clear that other simpler or more complex classifications could be used.

As by way of example, a 40 minute slide presentation that involves four segments of one slide for each segment may be assigned 5 minutes to the first slide with a 30 second warning time threshold, 10 minutes to the second slide with a 1 minute warning threshold, 15 minutes to the third slide with a 1 minute warning threshold and 10 minutes to the fourth slide with a 1 minute threshold.

In accordance with one embodiment, in the above example if the first slide uses 3 minutes of actual elapsed presentation time rather than the assigned 5 minutes, no warning is given and the 2 minute underrun in time may be carried over and added to the 10 minutes assigned to the second slide giving the second slide 12 minutes of presentation time rather than the preassigned 10 minutes. If the second slide uses 14 minutes of actual elapsed presentation time, a warning is given at 11 minutes of actual elapsed presentation time and the 2 minutes of overrun in time from the 12 minutes of time assigned time the second slide is carried over and subtracted from the 15 minutes assigned to the third slide giving the third slide 13 minutes of presentation time rather than the preassigned 15 minutes, and so on.

Thus, the overrun in times or underrun in times, if any, may be carried forward to algebraically add or subtract the deficit or surplus in times of the current slide to the next slide and so on. Alternatively, deficit or surplus times from a current slide may be carried forward and shared by succeeding slides on a pro-rate basis such as by an equal division of time among the slides or a division of time proportional to the preassigned presentation times of the slides. Some other formulas may also be chosen but it is convenient and advantageous to carry forward such times from slide to slide.

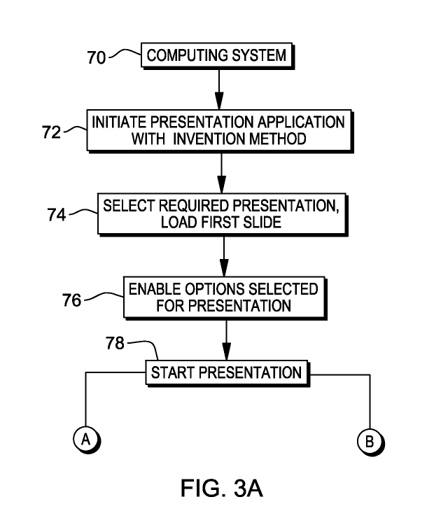

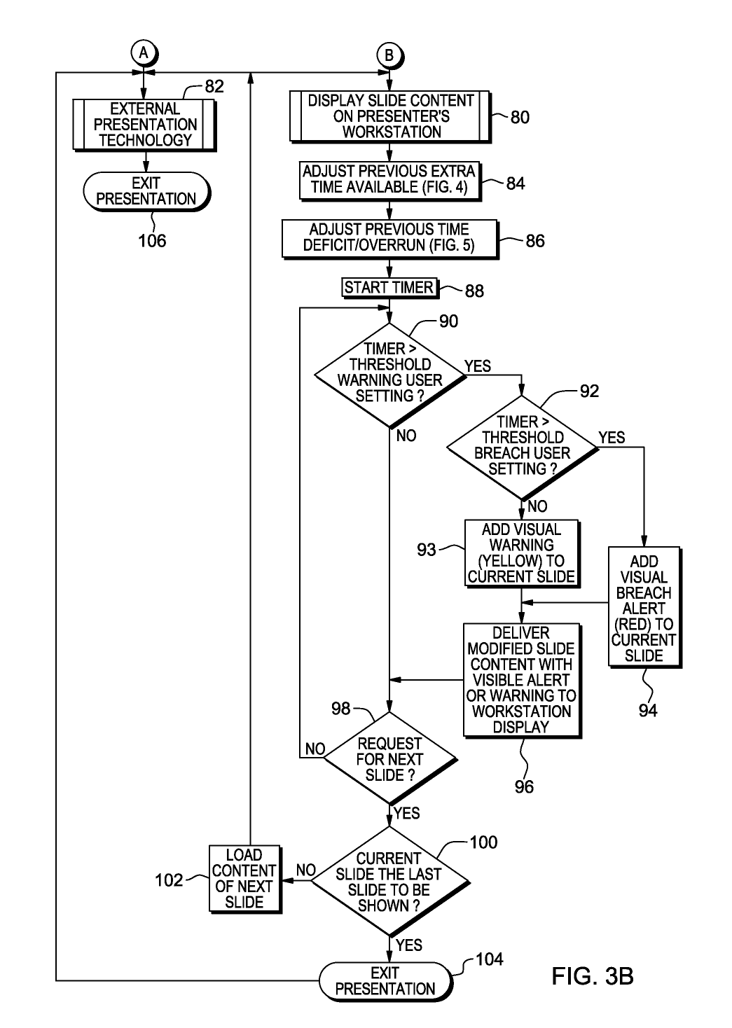

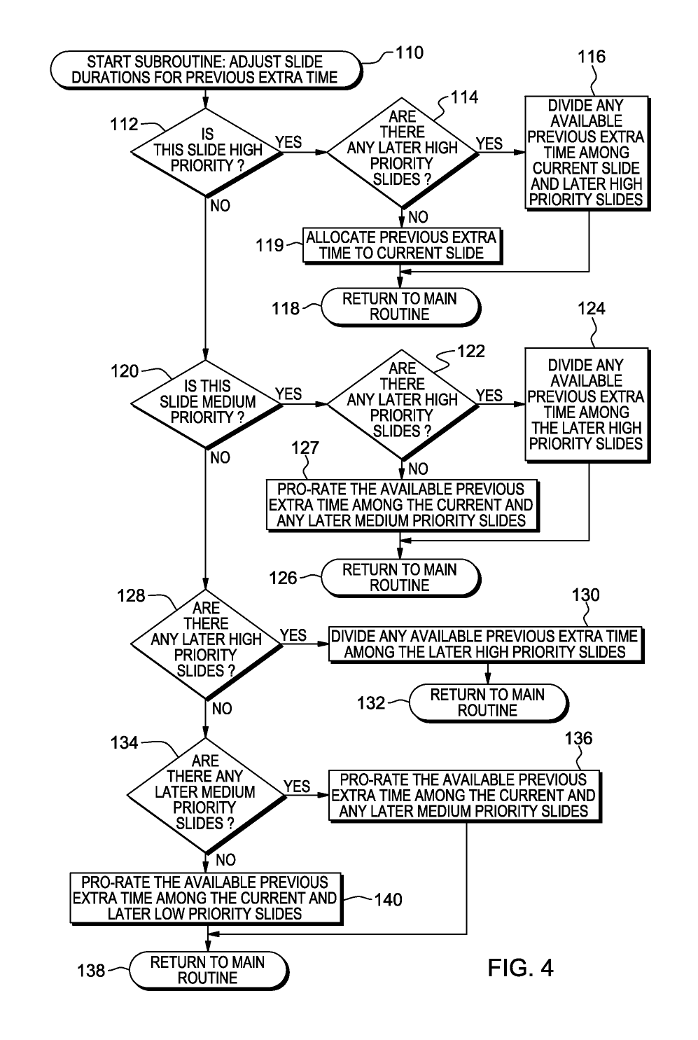

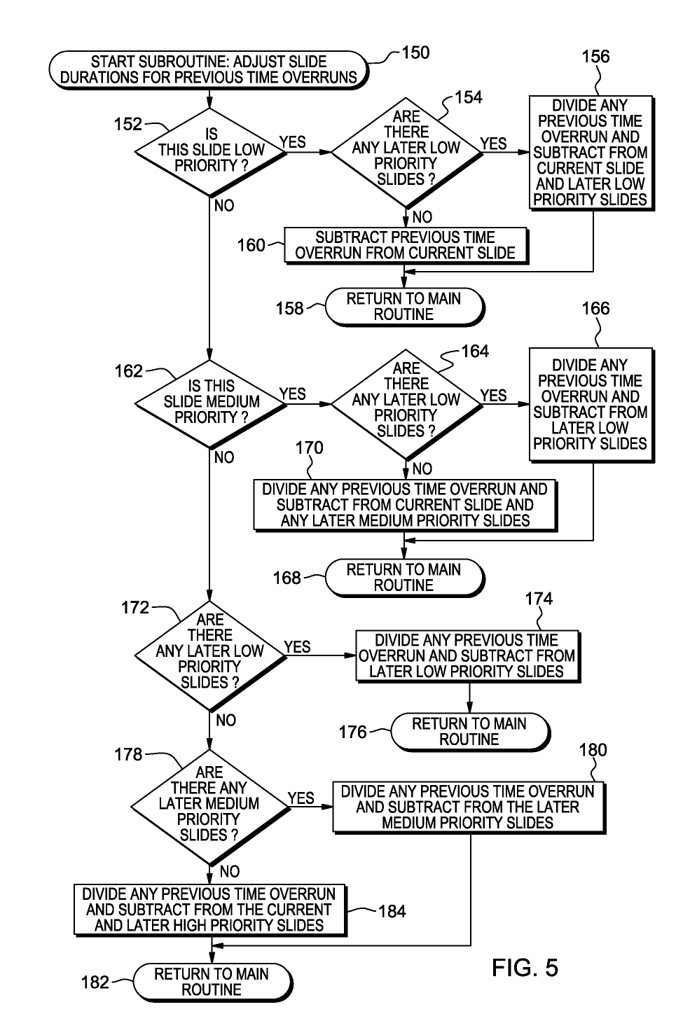

In regard to the latter, in accordance with an embodiment of the invention, illustratively shown in FIGS. 3A and 3B and further embodied in FIGS. 4 and 5, surplus or deficit time from a current slide is apportioned to succeeding slides according to a preassigned priority. In accordance with the priority scheme example employed here, the presenter preassigns any one of a “high priority”, “medium priority” or “low priority” to each segment.

As shown in FIG. 3A, the process starts at the presenter workstation by which the computer system 70 that hosts the presentation application program is engaged to initiate the process at step 72 on the computer system. The presenter selects the appropriate presentation at the step of block 74 and any options that may be available, such as selecting alternatives in apportioning surplus or deficit time, are selected at block 76. The presentation starts at the step of block 78 wherein the presenter initiates presentation of the first page of display content such as a slide wherein, for example, each slide is a presentation segment. The display of each slide is under control of the presenter and thus the overrun or underrun in times from the preassigned presentation times for each slide is controlled by the presenter based upon the presenter's decision and judgment notwithstanding the warning indications such as yellow and red warning indications displayed at the presenter workstation.

As shown at block 80 in FIG. 3B, presentation segments displayed at the presenter's workstation display shows slide content in addition to warning indications, such as a green band representing a “go” or “O.K.” condition. Block 82 represents the overhead display for audience viewing with no warning indication displayed. The step or process depicted by block 84 involves apportioning or adjusting time where surplus or extra time is available following the current slide due to an underrun in time from the preassigned time. Such process will be explained in the description following with respect to FIG. 4. In the step or process depicted by block 86, deficit time due to an overrun in the preassigned presentation time following the current slide is apportioned according to the process described with respect to FIG. 5.

At the step depicted by block 88 in FIG. 3B, the timer that tracks the actual elapsed time of each slide as it is presented is started. At the step of block 90, a decision is made as to whether the preassigned threshold warning time has been reached, i.e. whether the tracked time is greater than threshold warning time. If “yes”, then a decision is made at block 92 as to whether the threshold warning time has been breached, i.e. whether the actual elapsed time is beyond the preassigned presentation time. If “yes”, a “red” alert is added to the content of the slide to be presented at presenter workstation display. This modified content slide is sent to the presenter workstation, as depicted by the step of block 96, and the slide with no warning added, i.e. unmodified, slide, is maintained at the overhead display. Where the decision step of block 92 determines that, the threshold warning time has not been breached, a yellow alert is added to the slide with content at block 93 and sent to the workstation via the instruction of block 96 until the presenter request the next slide as shown by block 98.

At the block 98 in FIG. 3B, a decision is made as to whether there is a request for another slide to be presented. If “no”, the timing process continues by looping back to the timer query of block 90. If there is a request for another slide to be presented, i.e. a “yes” at decision block 98, another decision is made at block 100 as to whether the current slide is the last slide to be shown. If “no” the process loops back by the “load” instruction of block 102 to blocks 80 and 82 to initiate display of the next slide. Block 82 represents this display of content without warning indications to be displayed at the overhead display while block 80 represents the display of content which may have a warning added at block 94 to be displayed at the presenter workstation.

Where the decision at block 100 is “yes”, i.e. this is the last slide to be shown, the presentation process ends at the workstation display and overhead display, as depicted by blocks 104 and 106.

FIG. 4 illustrates a flow chart of an exemplary subroutine embodiment for allocating surplus time due to an underrun in time from a preassigned presentation time duration of a previous slide to current and later slide presentation durations. The subroutine starts at block 110 and a decision is made at block 112 as to whether the current slide, i.e. next slide in the sequence, is a high priority slide. If the decision is “yes”, another decision is made at block 114 as to whether there are any later high priority slides. If the answer is “yes” to the latter decision, the process acts at the step of block 116 to divide any available surplus time among the current high priority slide and later high priority slides and the process returns to the main routine as shown by block 118. Where the decision at block 114 is “no”, i.e. there are no later high priority slides, the available surplus time is allocated to the current high priority slide by the step of block 119 and the process returns to the main routine, as shown by block 118, to address the next slide.

Where the decision at block 112 is “no”, i.e. the current slide is not a high priority slide, the process moves to block 120 where a decision is made as to whether the current slide is a medium priority slide. If the answer is “yes”, a decision is then made at block 122 as to whether there are any later high priority slides. If the answer is “yes”, then any available surplus time is divided among any later high priority slides by the step of block 124 and the process returns to the main routine, as shown by block 126. Where the decision at block 122 is “no”, i.e. there are no later high priority slides, any available surplus time is divided among the current and any later medium priority slides by the step of block 127.

Where the answer to the query at block 120 is “no”, i.e. the current slide is not a medium priority slide, the process moves to the query at block 128 where a decision is made as to whether there are any later high priority slides. If the answer is “yes”, then any available surplus time is divided among any later high priority slides as shown by the step of block 130, and the process returns to the main routine as shown by block 132.

Where there are “no” later medium priority slides as determined at block 128, the process moves to block 134 where a decision is made as to whether there are any later medium priority slides. If the decision is “yes”, any available surplus time is divided among any later medium priority slides as shown by the step of block 136 and the process returns to the main routine via the step of block 138. Where, however, it is determined at block 134 that there are no later medium priority slides, any available surplus time is divided among any later low priority slides, as shown by the step of block 140 and the process returns to the main routine via the step of block 138.

The division of time throughout the subroutines of FIGS. 4 and 5 may be on a pro-rata basis where the available surplus or deficit time is divided and apportioned equally. However, it is clear that other approaches for allocating the time among the available slides may be used. For example, the surplus or deficit time may be allocated so that the division of time to be shared is proportional to the originally preassigned time.

FIG. 5 illustrates a flow chart of an exemplary subroutine embodiment for allocating deficit time due to an overrun in time from a preassigned presentation time duration of a previous slide so as to subtract the deficit time from current and later slide presentation durations according to priority. This subroutine to adjust slide durations for previous overruns starts at block 150 and the first step to be made at block 152 is to determine if the next slide, i.e. the current slide being addressed by this subroutine, is a low priority slide. If “yes”, the process branches to decision block 154 where a decision is made as to whether there are later lower priority slides in the presentation. If the answer is “yes”, the time deficit due to the previous time overrun is allocated to the current and later low priority slides by dividing the time deficit among the current and later low priority slides so as to shorten the preassigned time durations of these low priority slides. The process then returns to the main routine via the step of block 158.

If the decision at block 154 is that there are “no” later low priority slides, the process moves to the step of block 160 where the time deficit is subtracted from the current slide and the process returns to the main routine via the step of block 158.

Where the decision at block 152 is “no”, i.e. the current slide is not a low priority slide, the subroutine moves to block 162 where a decision is made as to whether the current slide is a medium priority slide. If the answer is “yes”, a determination is made at the decision point of block 164 as to whether there are any later low priority slides. If the answer is “yes”, the time deficit due to the previous overrun is divided in the step of block 166 among any later low priority slides so as to shorten the preassigned time duration for these later low priority slides. The process then returns to the main routine at block 168.

Where the decision at block 164 is that there are no latter low priority slides, the time deficit is divided among the current and any later medium priority slides via the step of block 170 and the process then returns to the main routine via block 168.

When the decision at block 162 is that the current slide is “not” a medium priority slide, the subroutine advances to decision block 172 where a determination is made as to whether there are any later low priority slides. If the answer is “yes”, the time deficit due to the previous time overrun is divided among any later low priority slides as shown by the step of block 174 to thereby shorten their preassigned time durations accordingly. The process then moves again to the main routine via the step of block 176.

Where is determined at block 172 that there are no later low priority slides, the process moves to the step of block 178 where a decision is made as to whether there are any later medium priority slides. If the answer is “yes”, the time deficit is divided among any later medium priority slides and subtracted to shorten the preassigned time duration of such slides, as shown by the step of block 180 and then returns, via the step of block 182, to the main routine. Where there are no later medium priority slides as determined at the step of block 178, the time deficit is divided, at the step of block 184, among any later high priority slides to shorten the preassigned time duration of such slides, and then the process returns to the main routine via block 182.

The flowchart and block diagrams in FIGS. 1 to 5, illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method of managing the distribution of time allocated to a plurality of sequential computer-based presentation segments, comprising:
storing a preassigned presentation time for each of said plurality of presentation segments to be presented in order on a presenter workstation display and on an audience display;
storing a preassigned warning time selected to be less than said presentation time for each of said plurality of presentation segments to use for initiation of an warning indication on the presenter workstation display if said warning time is reached;
initiate presentation to display presentation segment content on said presenter workstation display and audience display;
track the actual time elapsed for each presentation segment as it is displayed;
compare the actual time elapsed to the preassigned warning time for each presentation segment;
send a warning indication to the presenter workstation if the warning time is reached for a presentation segment;
compare the actual time elapsed to each preassigned presentation time for each presentation segment; and
carry forward any overrun or underrun variations in actual time from the preassigned presentation time to subtract or add the amount of such variations in actual time from the preassigned presentation time to succeeding presentation segments in the sequence of presentation segments.

2. The method of managing the distribution of time allocated to a plurality of sequential computer-based presentation segments of claim 1 wherein after each presentation segment in said sequence of presentation segments, any net accumulated variation in actual times from the summation of the preassigned presentation times of the presented segments is carried forward to the succeeding presentation segments.

3. The method of managing the distribution of time allocated to a plurality of sequential computer-based presentation segments as set forth in claim 1 wherein each presentation segment is preassigned a priority level.

4. The method of managing the distribution of time allocated to a plurality of computer-based presentation segments as set forth in claim 3, wherein said overrun and underrun variations in actual time from the preassigned presentation times are carried forward and distributed to subsequent presentation segments by assigning such variations in time according to the preassigned priority level.

5. The method of managing the distribution of time allocated to a plurality of computer-based presentation segments as set forth in claim 4, wherein said overrun variations in time are assigned to lower priority level presentation segments.

6. The method of managing the distribution of time allocated to a plurality of computer-based presentation segments as set forth in claim 4, wherein said underrun variations in time are assigned to higher priority level segments.

7. The method of managing the distribution of time allocated to a plurality of computer-based presentation segments as set forth in claim 4, wherein the workstation display is arranged to present a color-coded warning area on the display surface of the workstation display with green to indicate the presenter actual presentation time is within the preassigned presentation time period before the preassigned warning period, yellow to indicate the presenter actual presentation time is within the preassigned warning period and red to indicate that the presenter actual presentation time has overrun the preassigned presentation time.

8. A system for of managing the distribution of time allocated to a plurality of sequential computer-based presentation segments, comprising:
system storage for storing a preassigned presentation time for each of said plurality of presentation segments to be presented in order on a presenter workstation display and on an audience display;
system storage for storing a preassigned warning time selected to be less than said presentation time for each of said plurality of presentation segments to use for initiation of a warning indication on the presenter workstation display if said warning time is reached;
a workstation display and an audience display arranged to receive the presentation segments;
a processor arranged to;
track the actual time elapsed for each presentation segment as it is displayed;
compare the actual time elapsed to the preassigned warning time for each presentation segment;
send a warning indication to the presenter workstation if the warning time is reached for a presentation segment;
compare the actual time elapsed to each preassigned presentation time for each presentation segment; and
carry forward any overrun or underrun variations in actual time from the preassigned presentation time to subtract or add the amount of such variations in actual time from the preassigned presentation time to succeeding presentation segments in the sequence of presentation segments.

9. The system for managing the distribution of time allocated to a plurality of sequential computer-based presentation segments of claim 8 wherein after each presentation segment in said sequence of presentation segments, any net accumulated variation in actual times from the summation of the preassigned presentation times of the presented segments is carried forward to succeeding presentation segments.

10. The system of as set forth in claim 8 wherein each presentation segment is preassigned a priority.

11. The system as set forth in claim 10, wherein said overrun and underrun variations in actual time from the preassigned presentation times are carried forward and distributed to subsequent presentation segments by assigning such variations in time according to the preassigned priority.

12. The system as set forth in claim 11, wherein said overrun variations in time are assigned to lower priority presentation segments.

13. The system as set forth in claim 11, wherein said underrun variations in time are assigned to higher priority segments.

14. The system as set forth in claim 11, wherein the workstation display is arranged to present a color-coded warning area on the display surface of the workstation display with green to indicate the presenter actual presentation time is within the preassigned presentation time period before the preassigned warning period, yellow to indicate the presenter actual presentation time is within the preassigned warning period and red to indicate that the presenter actual presentation time has overrun the preassigned presentation time.

15. A computer program product for managing the distribution of time allocated to a plurality of sequential computer-based presentation segments, comprising:
a computer usable medium having computer usable program code embodied therewith, the computer usable program comprising:
computer usable program code configured to selectively access a stored preassigned presentation time for each of said plurality of presentation segments to be presented in order on a presenter workstation display and on an audience display;
computer usable program code configured to selectively access a stored preassigned warning time selected to be less than said presentation time for each of said plurality of presentation segments to use for initiation of an alarm indication on the presenter workstation display if said warning time is reached;
computer usable program code configured to commence presentation to display presentation segment content on said presenter workstation and audience display;
computer usable program code configured to track the actual time elapsed for each presentation segment as it is displayed;
computer usable program code configured to compare the actual time elapsed to each preassigned warning time for each presentation segment;
computer usable program code configured to send a warning indication to the presenter workstation if the warning time is reached;
computer usable program code configured to compare the actual time elapsed to each preassigned presentation time for each presentation segment; and
computer usable program code configured to carry forward any overrun or underrun variations in actual time from the preassigned presentation time to subtract or add the amount of such variation time from the preassigned presentation time to succeeding presentation segments in said sequence of segments.

16. The computer program product for managing the distribution of time allocated to a plurality of sequential computer-based presentation segments of claim 15 wherein computer usable program code is configured to act after each presentation segment in said sequence of presentation segments to carry forward to succeeding presentation segments any net accumulated variation in actual times from the summation of the preassigned presentation times of the presented segments.

17. The computer program product as set forth in claim 15 wherein each presentation segment is preassigned a priority level.

18. The computer program product as set forth in claim 17, wherein computer usable program code is configured to carry forward and distribute said overrun and underrun variations in actual time from the preassigned presentation times to subsequent presentation segments by assigning such variations in time according to the preassigned priority level.

19. The computer program product as set forth in claim 18, wherein said overrun variations are assigned to lower priority level presentation segments.

20. The computer program product as set forth in claim 18, wherein said underrun variations are assigned to higher priority level segments.
